(19) United States
(12) Patent Application Publication
(10) Pub. No.: US 2026/0030527 A1
(43) Pub. Date: Jan. 29, 2026

(54) METHOD, DEVICE, MEDIUM AND PROGRAM PRODUCT FOR CONTENT RECOMMENDATION

(71) Applicant: Beijing Zitiao Network Technology Co., Ltd., Beijing (CN)

(72) Inventor: Yanghua Wang, Beijing (CN)

(21) Appl. No.: 19/279,065

(22) Filed: Jul. 24, 2025

(30) Foreign Application Priority Data
Jul. 24, 2024 (WO) PCT/CN2024/107404

(51) Int. Cl. G06N 5/04; G06N 5/022

(52) U.S. Cl. CPC G06N 5/04; G06N 5/022

(57) ABSTRACT

According to embodiments of the present disclosure, a solution for content recommendation is provided. A method for content recommendation includes: obtaining historical conversion parameter values corresponding to a set of historical recommended contents related to a plurality of content elements; determining respective contribution scores of the plurality of content elements in the conversion based on the historical conversion parameter values corresponding to the set of historical recommended contents; determining, based at least on the respective contribution scores of the plurality of content elements, respective importance scores corresponding to a plurality of candidate recommended contents, each candidate recommended content including at least one content element of the plurality of content elements; and selecting, based on the importance scores corresponding to the plurality of candidate recommended contents, at least one recommended content from the plurality of candidate recommended contents for providing to a first user group.

This application claims the priority of International Patent Application No. PCT/CN2024/107404, filed on Jul. 24, 2024, entitled “METHOD, APPARATUS, DEVICE, MEDIUM AND PROGRAM PRODUCT FOR CONTENT RECOMMENDATION”, the entirety of which is incorporated herein by reference.

### FIELD

Example embodiments of the present disclosure generally relate to the computer technical field, and more particularly, to a method, apparatus, electronic device, computer readable storage medium and computer program product for content recommendation.

### BACKGROUND

The Internet offers access to a wide variety of resources. For example, various applications, commodities, audio and video content, and the like may be accessed through the Internet. In addition, content delivery and service promotion through the Internet are widely applied as new forms of information propagation. advertisement systems support presentation of recommended content to users in different advertisement presenting occasions, enabling users to browse and obtain corresponding services according to needs and thus achieving conversion of the recommended content. Therefore, how to provide a user with higher-quality recommended contents that better meets expectations remains an issue under study in recommendation scenarios.

### SUMMARY

In a first aspect of the present disclosure, a method of content recommendation is provided. The method includes: obtaining historical conversion parameter values corresponding to a set of historical recommended contents related to a plurality of content elements, each historical recommended content including at least one content element of the plurality of content elements; determining respective contribution scores of the plurality of content elements in the conversion based on the historical conversion parameter values corresponding to the set of historical recommended contents; determining, based at least on the respective contribution scores of the plurality of content elements, respective importance scores corresponding to a plurality of candidate recommended contents, each candidate recommended content including at least one content element of the plurality of content elements; and selecting, based on the importance scores corresponding to the plurality of candidate recommended contents, at least one recommended content from the plurality of candidate recommended contents for providing to a first user group.

In a second aspect of the present disclosure, an electronic device is provided. The device includes: at least one processing unit; and at least one memory, coupled to the at least one processing unit and storing instructions executed by the at least one processing unit. The instructions, when executed by the at least one processing unit, cause the device to: obtain historical conversion parameter values corresponding to a set of historical recommended contents related to a plurality of content elements, each historical recommended content including at least one content element of the plurality of content elements; determine respective contribution scores of the plurality of content elements in the conversion based on the historical conversion parameter values corresponding to the set of historical recommended contents; determine, based at least on the respective contribution scores of the plurality of content elements, respective importance scores corresponding to a plurality of candidate recommended contents, each candidate recommended content including at least one content element of the plurality of content elements; and select, based on the importance scores corresponding to the plurality of candidate recommended contents, at least one recommended content from the plurality of candidate recommended contents for providing to a first user group.

In a third aspect of the present disclosure, an apparatus for content recommendation is provided. The apparatus includes: a conversion obtaining module configured to obtain historical conversion parameter values corresponding to a set of historical recommended contents related to a plurality of content elements, each historical recommended content including at least one content element of the plurality of content elements; a contribution determining module configured to determine respective contribution scores of the plurality of content elements in the conversion based on the historical conversion parameter values corresponding to the set of historical recommended contents; an importance determining module configured to determine, based at least on the respective contribution scores of the plurality of content elements, respective importance scores corresponding to a plurality of candidate recommended contents, each candidate recommended content including at least one content element of the plurality of content elements; and a content selecting module configured to select, based on the importance scores corresponding to the plurality of candidate recommended contents, at least one recommended content from the plurality of candidate recommended contents for providing to a first user group.

In a fourth aspect of the present disclosure, a computer readable storage medium is provided. The medium stores a computer program thereon, which, when executed by a processor, implements the method according to the first aspect of the present disclosure.

In a fifth aspect of the present disclosure, a computer program product is provided. The computer program product includes computer-executable instructions which, when executed by a processor, implement the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective implementations of the present disclosure will become more apparent from the following detailed description with reference to the accompanying drawings. The same or similar reference numerals represent the same or similar elements throughout the figures, where:

FIG. 1 illustrates a schematic diagram of an example environment in which embodiments of the present disclosure can be implemented;

FIG. 2 illustrates a flowchart of a process of generating recommended content according to some embodiments of the present disclosure;

FIG. 3 illustrates a flowchart of a process for content recommendation according to some embodiments of the present disclosure;

FIG. 4 illustrates a block diagram of an apparatus for content recommendation according to some embodiments of the present disclosure; and

FIG. 5 illustrates a block diagram of an electronic device in which one or more embodiments of the present disclosure may be implemented.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

As used herein, the terms “comprise/include” and their variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below. The terms “first”, “second” and the like may refer to different or identical objects. Other explicit and implicit definitions may also be included below.

It is to be understood that the data involved in this technical solution (including but not limited to the data itself, data acquisition, use, storage or deletion) should comply with the requirements of corresponding laws and regulations and relevant provisions.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

The “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, increasing the depth of the network. Respective layers of the neural network are connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may generally include three stages, a training stage, a testing stage, and an application stage (also referred to as an inference stage). At the training stage, a given model may be trained using a large amount of training data, the parameter values are updated iteratively, until the model is able to obtain consistent inferences from the training data that satisfy the expected objectives. By training, the model may be considered to be able to learn from the training data an association from input to output (also referred to as mapping of input to output). The parameter values of the trained model are determined. In the testing stage, the test input is applied to the trained model, and the test model can provide correct output, thereby determining the performance of the model. At the application stage, the model may be used to process the actual input based on the parameter value obtained by training to determine a corresponding output.

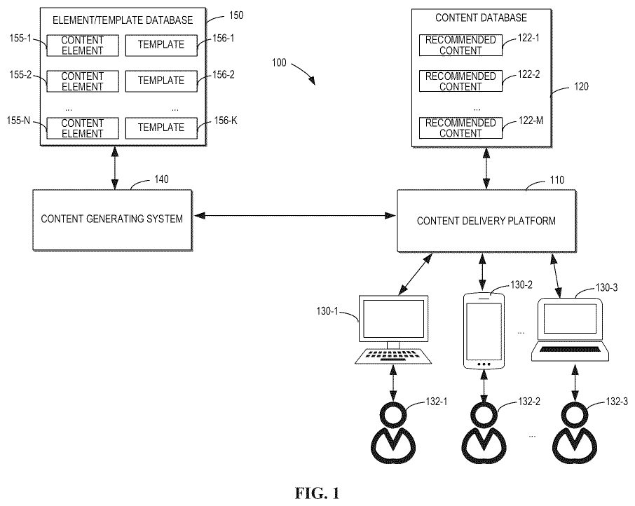

FIG. 1 illustrates a schematic diagram of an example environment 100 in which embodiments of the present disclosure can be implemented. One or more client devices 130-1, 130-2, 130-3, etc. (collectively or individually referred to as client devices 130 for ease of discussion) are associated with a content delivery platform 110 and may access various content provided on the content delivery platform 110, e.g., based on respective users 132-1, 132-2, 132-3, etc. (collectively or individually referred to as users 132 for ease of discussion). As an example, the content delivery platform 110 may be an application, a website, a web page, and other accessible platforms. The client device 130 may be installed with an application for accessing the content delivery platform 110, or may access the content delivery platform 110 in a suitable manner.

The content delivery platform 110 may be configured to deliver, to a user group, one or more specific recommended content (e.g., provided or presented at the client device 130) related to one or more objects based on a respective recommendation policy. The recommended content to be delivered may include, for example, one or more recommended content 122-1, 122-2, . . . 122-M (collectively or individually referred to as recommended content 122 for ease of discussion) in a content database 120. The recommended content 122 is also sometimes referred to as a “material” or a recommended material.

Examples of objects that may be recommended herein may include applications, entity commodities/services, virtual commodities/services, digital content/entity content, and the like. Herein, the “recommended content” refers to content that is presented in order to recommend corresponding objects. Examples of the recommended content may include advertisements. Herein, the user group may include one or more user members, such as the user 132. The user member may be any potential recipient or consumer of a service, such as a user, group, organization, entity, or the like. In some embodiments, the content delivery platform 110 may provide the corresponding recommended content 122 to the user group based on a request of a recommendation requester. In a scenario of advertisement delivery, a service provider is sometimes also referred to as an advertiser.

The recommended content 122 delivered by the content delivery platform 110 may be generated by a content generating system 140. The content generating system 140 may be configured to select content elements from content elements 155-1, 155-2, . . . 155-M (collectively or individually referred to as content elements 155) stored in an element/template database 150 for generating the recommended content 122. Each recommended content 122 may include one or more content elements 155. The content elements 155 may include multimedia content such as images, videos, text, music, other audios, and the like. By organizing these content, more complex recommended content may be formed for provision to the user. The content element 155 is sometimes also referred to as a “material”, “material element” or “material unit” for generating a material.

The source of the content element 155 may be diversified, may include a data source uploaded by the recommendation requester and specified by the recommendation requester, or may be user generated content (UGC) (of course, the use of such content is authorized by the user), and so on.

In some embodiments, the content generating system 140 may also access templates 156-1, 156-2, . . . 156-K (collectively or individually referred to as templates 156) in the element/template database 150. The content generating system 140 may select a template 156 for generating the recommended content 122. Each template may define an organization/editing manner of content or content layout of the recommended content, and may define placeholders, each of which may be used to populate one content element 155. By means of the templates, the content generating system 140 may more efficiently generate the diversified recommended content 122.

In the environment 100, the client device 130 may be any type of mobile terminal, fixed terminal, or portable terminal, including a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some embodiments, the client device 130 can also support any type of interface for a user (such as a “wearable” circuit, etc.).

In the environment 100, the content delivery platform 110, a recommendation conversion component 140, and or a recommendation management system 150 may be, for example, various types of computing systems/servers capable of providing computing power, including, but not limited to, mainframes, edge computing nodes, computing devices in a cloud environment, and so forth. Although illustrated separately, one or more of the content delivery platform 110, the recommendation conversion component 140, and/or the recommendation management system 150 may be combined.

It should be understood that the components and arrangements in the environment shown in FIG. 1 are merely examples, and that the computing system suitable for implementing the example embodiments described in this disclosure may include one or more different components, other components, and/or different arrangements.

For content recommendation, in order to improve recommendation efficiency and effect, it is desirable to provide high-quality recommended content (material) for delivery.

Generally, when generating the material for recommendation, the content element may be filtered based on relevant indicators for synthesizing the recommended content. For example, high-quality videos may be filtered based on relevant video indicators such as video or picture views, likes, favorites and the like, and may be used as raw materials for production of the recommended content. During generating the recommended content, different videos or pictures may be combined in a certain spatial or temporal manner by means of video synthesis capability. In addition, diversified recommended content may be generated in batches for delivery by means of audio synthesis capability.

In the traditional generation process of recommended content, the recall logic of the content element, the synthesis logic of the recommended content, and the delivery logic of the finally generated recommended content are independent of each other, and do not depend on each other. The policy for each stage depends on the manual configuration. As such, when analyzing the conversion effect after the delivery of recommended content, it is difficult to attribute to a specific policy in the preamble process. This may impact mining and iterating on higher quality recommended content. Generally, there is a large number of initial content elements, so there are more combination manners of the content elements. How to determine the highest quality recommended content from a large number of combinations is a matter of great concern and improvement.

In the embodiments of the present disclosure, an improved solution for content recommendation is provided. For a plurality of content elements, firstly, based on historical recommended content generated by these content elements, conversion of the historical recommended content is analyzed to obtain historical conversion parameter values corresponding to the historical recommended content. Respective contribution scores of the plurality of content elements in the conversion are determined based on the historical conversion parameter values corresponding to the historical recommended content.

Importance scores corresponding to a plurality of candidate recommended contents are determined based at least on the respective contribution scores of the plurality of content elements, wherein each candidate recommended content includes at least one of the plurality of content elements. At least one recommended content is selected, based on the importance scores corresponding to the plurality of candidate recommended contents, from the plurality of candidate recommended contents for provision to a first user group.

According to the solution, the historical conversion parameter value of the recommended content is attributed to the granularity of each content element. By measuring the contribution degree of each content element in the historical conversion, the value of the candidate recommended content, i.e., the importance score, may be estimated. In this way, high-quality recommended content may be filtered out for subsequent delivery in the content production stage. Therefore, the conversion efficiency of subsequent content delivery may be improved, and the user may receive high-quality recommended content.

Some example embodiments of the present disclosure will be described below with reference to the accompanying drawings.

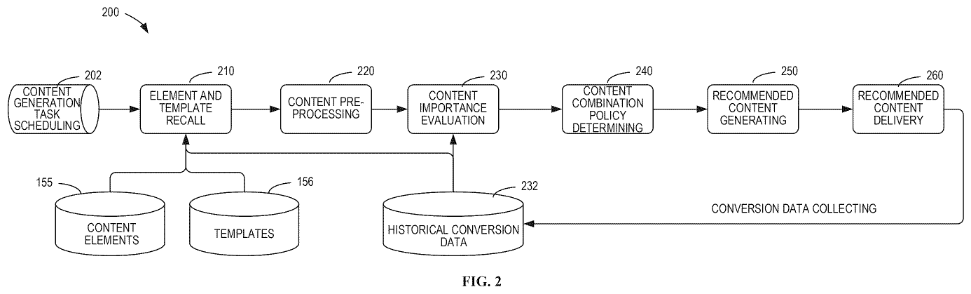

FIG. 2 illustrates a flowchart of a process 200 for generating recommended content according to some embodiments of the present disclosure. For ease of discussion, description will be made with reference to FIG. 1. The process 200 may be implemented at the content generating system 140.

The content generating system 140 may determine, in response to content generation task scheduling 202, that one or more recommended content 122 are to be generated to provide to a user group. The content generation task scheduling 202 may be periodic or triggered in response to a configured condition. This is not limited in the embodiments of the present disclosure.

At the stage of an element and template recall 210, the content generating system 140 may select a plurality of content elements 155 for content generation according to a recall policy. In some embodiments, the plurality of content elements 155 may be content elements related to a particular object. The recall policy may specify an identifier of the object. In some embodiments, the recall policy may further include preconfigured rules including content requirements specified by a recommendation requester, i.e., views requirements, likes requirements, comments requirements, whether there are specific labels, and the like for content elements.

In some embodiments, for some types of recommended content, or depending on the specific content generation policy, the content generating system 140 may also select one or more templates 156 for content generation. The filtered content elements 155 and templates 156 may be subjected to a stage of content preprocessing 220 to preprocess various content elements. The preprocessing operation may be, for example, a size transformation or a filter beautification on the content element.

Generally, where there is still a large number of the content elements 155 and the templates 156 filtered out while meeting the requirements, if the content elements 155 are embedded into the specific template 156 through permutation and combination for picture or video generation, then many recommended content will be obtained, and some of these recommended contents may not be high-quality and will not obtain user conversion. Accordingly, it is desirable for the content generating system 140 to generate higher quality recommended content at the content generation stage.

In the embodiments of the present disclosure, the content generating system 140 performs a stages of content importance assessment 230. For the content importance assessment 230, the content generating system 140 analyzes historical conversion data 232 of the recommended content (also referred to as historical recommended content) delivered over a past period of time to determine a historical conversion parameter value for each historical recommended content item. The historical recommended content concerned refers to recommended content including the one or more content elements 155 filtered at the stage of element and template recall 210. In some embodiments, in the case of using the template 156, the historical recommended content further includes the filtered template 156.

The historical conversion data 232 may be conversion data collected after the historical recommended content is provided to the user group for a period of time. At the initial stage, such delivery of recommended content is referred to as a cold-start stage of recommended content, at which point there may be no historical conversion data.

The conversion parameter is used to measure conversion efficiency of recommended content after being provided to a plurality of users or delivered for a period of time, including a probability that the user performs a conversion behavior, or an indicator value-added (or a revenue value-added) corresponding to a conversion behavior performed by the user. When the historical recommended content is provided to the user group, the conversion parameter (or conversion indicator) concerned may be determined according to the specific application scenario and the object type corresponding to the delivered recommended content. For example, if the object involved in the recommended content is an application, and the conversion behavior concerned is installation of the application, the conversion parameter may include an IPC (Install per created) brought by each recommended content, and/or an IPM (Install per mile) brought by the recommended content per thousand exposures. The conversion behavior or conversion parameter concerned may be different for other types of objects. For example, for online content, the conversion behavior concerned is an interaction behavior, for example, like, favorite, comment, etc., and the conversion parameter concerned may be likes, favorites or comments brought by the recommended content per thousand exposures; for a commodity, the conversion behavior concerned may be an access to a commodity detail page, adding to a cart, a purchase, and the like, and the conversion parameter concerned may be visits brought by the recommended content per thousand exposures, an amount of adding to a cart, an amount of purchases, and the like.

At the cold-start stage, in order to collect conversion data, a plurality of content elements 155 (and also a random selection template 156) may be randomly combined to generate a set of recommended content for delivery to a certain user group, and conversion data of the recommended content is collected to obtain a corresponding historical conversion parameter value. These recommended content is used as historical recommended content subsequently, and their conversion parameter values are used as historical conversion parameter values for improving subsequent recommended content generation processes. In some embodiments, after the recommended content generated according to the above embodiments is delivered, the conversion data of these recommended content may continue to be collected, and the converted data is stored as the historical conversion data 232 for continuing to support a further subsequent generation process of recommended content.

After obtaining the historical conversion parameter values corresponding to the set of historical recommended contents related to the plurality of content elements 155, respective contribution scores of the plurality of content elements 155 in the conversion may be determined based on the historical conversion parameter values corresponding to the historical recommended content. In this way, although only the overall conversion parameter value of the recommended content may be collected after delivery of the recommended content, the contribution of the content element included in the recommended content may be measured on the basis of the overall conversion parameter. The contribution score of each content element 155 has made reference to conversion data corresponding to the portion of previously delivered recommended content which includes the content element.

In this way, the importance scores corresponding to the plurality of candidate recommended contents may be determined based on the respective contribution scores of the plurality of content elements 155. Each candidate recommended content to be measured here includes at least one of the plurality of content elements 155. In some embodiments, in the case of considering the template 156, similarly, respective contribution scores of the plurality of templates 156 in the conversion may also be determined based on the historical conversion parameter values corresponding to the historical recommended content. In this way, the content generating system 140 may determine, based on the respective contribution scores of the plurality of content elements 155 and the respective contribution scores of the plurality of templates 156, the importance scores corresponding to the plurality of candidate recommended contents. Each candidate recommended content also includes a template 156 for organizing the content elements 155.

In some embodiments, when determining the contribution score of the content element 155, the content generating system 140 may determine, from the respective historical conversion parameter values corresponding to the set of historical recommended contents, historical conversion parameter values corresponding to the respective historical recommended contents including the content element 155. The content generating system 140 determines a contribution score of the content element 155 based on the number of respective historical recommended contents including the content element 155 and the historical conversion parameter values corresponding to the respective historical recommended contents.

Similarly, when determining the contribution score of the template 156, the content generating system 140 may determine, from the respective historical conversion parameter values corresponding to the set of historical recommended contents, the historical conversion parameter values corresponding to the respective historical recommended contents including the template 156. The content generating system 140 may determine a contribution score of the template 156 based on the number of respective historical recommended contents including the template 156 and the historical conversion parameter values corresponding to the respective historical recommended contents.

When determining the importance score corresponding to each candidate recommended content, the content generating system 140 may determine the number of content elements 155 to be included in each candidate recommended content. In some embodiments, the number of content elements 155 to be included in each candidate recommended content is related to the selected template, e.g., depending on a placeholder as defined in the template. In some embodiments, if not depending on the template, the number of content elements 155 to be included in each candidate recommended content may be randomly defined.

In this way, when calculating the importance score of each candidate recommended content, the importance score of the candidate recommended content may be determined by weighted sum, weighted average and the like based on the contribution score of the included content element 155 and the contribution score of the template 156. In some embodiments, a weight of the content element 155 and a weight of the template 156 may be separately configured, e.g., may be configured as different weights. For example, the weight of the content element 155 may be greater than the weight of the template 156. In some embodiments, the weights of different types of content elements 155 may also be different. The specific value of the weight may be configured according to an actual application, and the scope of the embodiments of the present disclosure is not limited in this respect.

Assuming that the filtered content elements are represented as x₁, x₂, . . . , xₙ, the templates are represented as y₁, y₂, . . . , yₘ, and each template includes k placeholders. Note that for ease of discussion only, it is assumed that the number of placeholders included in each template is equal, but the number of placeholders included in different templates may be different in actual application. Assuming after recommended content is obtained through permutation and combination of the foregoing content elements and then is delivered, the historical conversion parameter of each recommended content is represented as V. At this point, the contribution scores of the content element and the template may be determined, and further the importance score of the candidate recommended content may be estimated:
Contribution score of content element 155=(V1+V2+ . . . Vn1)/the number n1 of historical recommended content generated using the content element.
Contribution score of template 156=(V1+V2+ . . . Vn2)/the number n2 of historical recommended content generated using the template:

$$Estimated importance score of candidate recommended content = \frac{contribution scores of ( xi + xj ... + xk )}{k} * w 1 + contribution score of \\ \\ template * w 1$$

where w1 and wi1 respectively indicate a weight of the content element and a weight of the template, and (xi+xj . . . +xk) represent k content elements included in the candidate recommended content (note that content elements included in different candidate recommended contents are different).

It should be understood that the above method of calculating the importance score of the candidate recommended content is merely an example, and other calculation methods may be configured.

The importance score corresponding to the candidate recommended content may measure the value of the recommended content, and the importance is determined by the degree of contribution of the content element to be included in the candidate recommended content in the historical recommendation process.

After the estimated importance score is obtained, at the stage of content combination policy determining 240, the content generating system 140 may determine, based on the respective determined importance scores corresponding to the plurality of candidate recommended contents, which combination mode is to be selected to generate the candidate recommended content. That is, when evaluating the content importance, it is not necessary to complete the composition of the candidate recommended content, but the importance corresponding to different combinations of the content element 155 and the template 156 may be evaluated. Then, depending on the determined importance score, the content generating system 240 may select a certain number of candidate recommended content with the highest importance score or importance score satisfying the expectation.

At the stage of recommended content generation 250, the content generating system 240 may generate at least one recommended content with a higher importance based on the determined content combination policy. At the stage of recommended content delivery 260, the content generating system 240 provides the at least one generated recommended content to the user group.

As mentioned above, the conversion data may be obtained in a random combination mode at the cold-start stage, and after the recommended content is generated based on the importance scores subsequently, the conversion data of the recommended content may still continue to be collected, and this part of conversion data continues to be used to update the contribution score of the content element and the template to realize the accumulation of dominant policies. In this way, the subsequent evaluation of the importance of the recommended content is made more accurate.

In some embodiments, after the important recommended content is selected for delivery based on the importance score, if the conversion parameter value of the recommended content is relatively high (for example, the conversion parameter value exceeds a conversion threshold), a label or other information of the template 156 or the content element 155 included in the at least one recommended content may also be determined. These labels or other relevant information may be used to direct and optimize recall policies for the recall stage in order to select, at the recall stage, other content elements templates that are similar to the content elements/templates in the high quality recommended content for generating the recommended content.

In some embodiments, due to the limited amount of recommended content which is eventually put to use and the infinite combinations of policies, in order to maximize the activity of the policy, besides selecting the recommended content for delivery based on the importance score, additional recommended content may be further generated by randomly combining the plurality of content elements 155. In a predetermined time period, additional recommended content and the recommended content selected based on the importance scores are provided to the user group. In other words, adaptive elimination may be achieved by controlling a certain percentage of recommended content production to use a better policy, while the rest of recommended content production maintains a random combination mode. This may ensure the flexibility of the policy, i.e., a new advantage combination policy may be determined subsequently, while an attenuated old-and-new combination policy may be iterated and replaced.

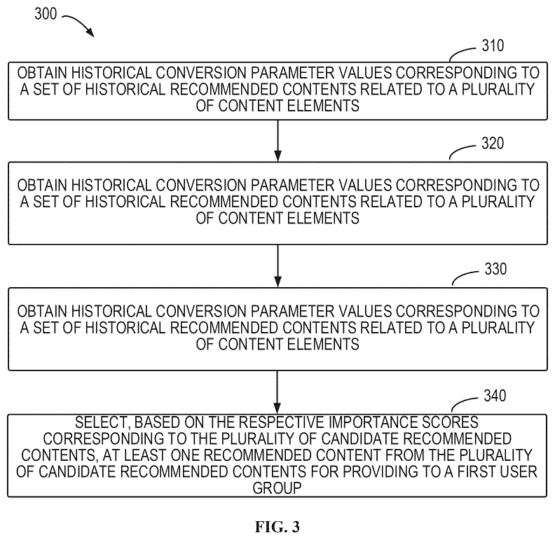

FIG. 3 illustrates a flowchart of a process 300 for content recommendation according to some embodiments of the present disclosure. The process 300 may be implemented, for example, in the content generating system 140 of FIG. 1.

At block 310, the content generating system 140 obtains historical conversion parameter values corresponding to a set of historical recommended contents related to a plurality of content elements, each historical recommended content including at least one content element of the plurality of content elements.

At block 320, the content generating system 140 determines respective contribution scores of the plurality of content elements in the conversion based on the historical conversion parameter values corresponding to the set of historical recommended contents.

At block 330, the content generating system 140 determines, based at least on the respective contribution scores of the plurality of content elements, respective importance scores corresponding to a plurality of candidate recommended contents, each candidate recommended content including at least one content element of the plurality of content elements.

At block 340, the content generating system 140 selects, based on the importance scores corresponding to the plurality of candidate recommended contents, at least one recommended content from the plurality of candidate recommended contents for providing to a first user group.

In some embodiments, determining respective contribution scores of the plurality of content elements in the conversion includes: for each content element in the plurality of content elements, determining historical conversion parameter values corresponding to respective historical recommended contents including the content element from the historical conversion parameter values corresponding to the set of historical recommended contents; and determining a contribution score of the content element based on the number of the respective historical recommended contents including the content element and the historical conversion parameter values corresponding to the respective historical recommended contents.

In some embodiments, each historical recommended content further includes a template that is selected from a plurality of templates for organizing at least one content element, and determining respective importance scores corresponding to the plurality of candidate recommended contents includes: determining respective contribution degree scores of the plurality of templates in the conversion based on the historical conversion parameter values corresponding to the set of historical recommended contents; and determining respective importance scores corresponding to the plurality of candidate recommended contents based on the respective contribution scores of the plurality of content elements and the respective contribution scores of the plurality of templates, each recommended content further including a template for organizing at least one content element.

In some embodiments, determining respective contribution scores of the plurality of templates in the conversion includes: for each template in the plurality of templates, determining historical conversion parameter values corresponding to respective historical recommended contents including the template from the respective historical conversion parameter values corresponding to the set of historical recommended contents; and determining a contribution score of the template based on the number of the respective historical recommended contents including the template and the historical conversion parameter values corresponding to the respective historical recommended contents.

In some embodiments, the process 300 further includes: generating at least one additional recommended content by randomly combining the plurality of content elements; and providing the at least one additional recommended content together with the at least one selected recommended content to the first user group within a predetermined time period.

In some embodiments, obtaining historical conversion parameter values corresponding to a set of historical recommended contents related to a plurality of content elements includes: generating the set of historical recommended contents by randomly combining the plurality of content elements; and after providing the set of historical recommended contents to a second user group, collecting historical conversion parameter values corresponding to the set of historical recommended contents.

In some embodiments, the process 300 further includes: after providing the at least one selected recommended content to the first user group, collecting at least one conversion parameter value corresponding to the at least one recommended content; in response to the at least one conversion parameter value corresponding to the at least one recommended content exceeding a conversion threshold, determining at least one label of a content element included in the at least one recommended content; and selecting, based at least on the at least one label, a content element from a content element set for generating the recommended content.

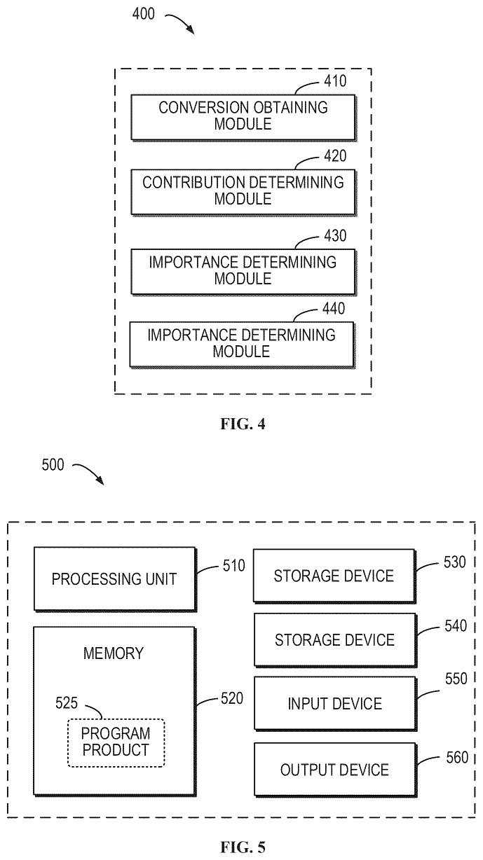

FIG. 4 shows a schematic structural block diagram of an apparatus 400 for content recommendation according to some embodiments of the present disclosure. The apparatus 400 may be implemented as or included in the content generating system 140 of FIG. 1. The various modules/components in the apparatus 400 may be implemented by hardware, software, firmware, or any combination thereof.

As shown in the figure, the apparatus 400 includes a conversion obtaining module 410 configured to obtain historical conversion parameter values corresponding to a set of historical recommended contents related to a plurality of content elements, each historical recommended content including at least one content element of the plurality of content elements. The apparatus 400 further includes a contribution determining module 420 configured to determine respective contribution scores of the plurality of content elements in the conversion based on the historical conversion parameter values corresponding to the set of historical recommended contents. The apparatus 400 includes an importance determining module 430 configured to determine, based at least on the respective contribution scores of the plurality of content elements, respective importance scores corresponding to a plurality of candidate recommended contents, each candidate recommended content including at least one content element of the plurality of content elements. The apparatus 400 further includes a content selecting module 440 configured to select, based on the importance scores corresponding to the plurality of candidate recommended contents, at least one recommended content from the plurality of candidate recommended contents for providing to a first user group.

In some embodiments, the contribution determining module 420 is further configured to: for each content element in the plurality of content elements, determine historical conversion parameter values corresponding to respective historical recommended contents including the content element from the historical conversion parameter values corresponding to the set of historical recommended contents; and determine a contribution score of the content element based on the number of the respective historical recommended contents including the content element and the historical conversion parameter values corresponding to the respective historical recommended contents.

In some embodiments, each historical recommended content further includes a template that is selected from a plurality of templates for organizing at least one content element. The importance determining module 430 is further configured to: determine respective contribution degree scores of the plurality of templates in the conversion based on the historical conversion parameter values corresponding to the set of historical recommended contents; and determine importance scores corresponding to the plurality of candidate recommended contents based on the respective contribution scores of the plurality of content elements and the respective contribution scores of the plurality of templates, each recommended content further including a template for organizing at least one content element.

In some embodiments, the importance determining module 430 is further configured to: for each template in the plurality of templates, determine historical conversion parameter values corresponding to respective historical recommended contents including the template from the respective historical conversion parameter values corresponding to the set of historical recommended contents; and determine a contribution score of the template based on the number of the respective historical recommended contents including the template and the historical conversion parameter values corresponding to the respective historical recommended contents.

In some embodiments, the apparatus 400 further includes: a random combination module configured to generate at least one additional recommended content by randomly combining the plurality of content elements; and provide the at least one additional recommended content together with the at least one selected recommended content to the first user group within a predetermined time period.

In some embodiments, the conversion obtaining module 410 is further configured to: generate the set of historical recommended contents by randomly combining the plurality of content elements; and after providing the set of historical recommended contents to a second user group, collect historical conversion parameter values corresponding to the set of historical recommended contents.

In some embodiments, the apparatus 400 further includes: a conversion collecting module configured to, after providing the at least one selected recommended content to the first user group, collect at least one conversion parameter value corresponding to the at least one recommended content;

in response to the at least one conversion parameter value corresponding to the at least one recommended content exceeding a conversion threshold, determine at least one label of a content element included in the at least one recommended content; and select, based at least on the at least one label, a content element from a content element set for generating the recommended content.

FIG. 5 illustrates a block diagram of an electronic device 500 in which one or more embodiments of the present disclosure may be implemented. It should be understood that the electronic device 500 illustrated in FIG. 5 is merely an example and should not constitute any limitation on the functionality and scope of the embodiments described herein. The electronic device 500 shown in FIG. 5 may be configured to implement the content generating system 140. The electronic device 500 may be included in or implemented as the apparatus 400 of FIG. 4.

As shown in FIG. 5, the electronic device 500 is in the form of a general purpose computing device. Components of the electronic device 500 may include, but are not limited to, one or more processors or processing units 510, a memory 520, a storage device 530, one or more communication units 540, one or more input devices 550, and one or more output devices 560. The processing unit 510 may be a physical or virtual processor and may execute various processing based on the programs stored in the memory 520. In a multi-processor system, a plurality of processing units executes computer-executable instructions in parallel to enhance parallel processing capability of the electronic device 500.

The electronic device 500 usually includes a plurality of computer storage mediums. Such mediums may be any attainable medium accessible by the electronic device 500, including but not limited to, a volatile and non-volatile medium, a removable and non-removable medium. The memory 520 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 530 may be a removable or non-removable medium, and may include a machine-readable medium (e.g., a memory, a flash drive, a magnetic disk) or any other medium, which may be used for storing information and/or data (e.g., training data for training) and be accessed within the computing device 500.

The electronic device 500 may further include additional removable/non-removable, volatile/non-volatile storage mediums. Although not shown in FIG. 5, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 520 may include a computer program product 525 having one or more program modules, and these program modules are configured for performing various methods or acts of various implementations of the present disclosure.

The communication unit 540 implements communication with another computing device via a communication medium. Additionally, functions of components of the electronic device 500 may be realized by a single computing cluster or a plurality of computing machines, and these computing machines may communicate through communication connections. Therefore, the electronic device 500 may operate in a networked environment using a logic connection to one or more other servers, a Personal Computer (PC) or a further general network node.

The input device 550 may be one or more various input devices, such as a mouse, a keyboard, a trackball, a voice-input device, and the like. The output device 560 may be one or more output devices, e.g., a display, a loudspeaker, a printer, and so on. The electronic device 500 may also communicate through the communication unit 540 with one or more external devices (not shown) as required, where the external device, e.g., a storage device, a display device, and so on, communicates with one or more devices that enable users to interact with the electronic device 500, or with any device (such as a network card, a modem, and the like) that enable the electronic device 500 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

What is claimed is:

1. A method of content recommendation, comprising:
obtaining historical conversion parameter values corresponding to a set of historical recommended contents related to a plurality of content elements, each historical recommended content comprising at least one content element of the plurality of content elements;
determining respective contribution scores of the plurality of content elements in the conversion based on the historical conversion parameter values corresponding to the set of historical recommended contents;
determining, based at least on the respective contribution scores of the plurality of content elements, respective importance scores corresponding to a plurality of candidate recommended contents, each candidate recommended content comprising at least one content element of the plurality of content elements; and
selecting, based on the importance scores corresponding to the plurality of candidate recommended contents, at least one recommended content from the plurality of candidate recommended contents for providing to a first user group.

2. The method of claim 1, wherein determining respective contribution scores of the plurality of content elements in the conversion comprises:
for each content element in the plurality of content elements,
determining historical conversion parameter values corresponding to respective historical recommended contents comprising the content element from the historical conversion parameter values corresponding to the set of historical recommended contents; and
determining a contribution score of the content element based on the number of the respective historical recommended contents comprising the content element and the historical conversion parameter values corresponding to the respective historical recommended contents.

3. The method of claim 1, wherein each historical recommended content further comprises a template that is selected from a plurality of templates for organizing at least one content element, and wherein determining respective importance scores corresponding to the plurality of candidate recommended contents comprises:
determining respective contribution degree scores of the plurality of templates in the conversion based on the historical conversion parameter values corresponding to the set of historical recommended contents; and
determining respective importance scores corresponding to the plurality of candidate recommended contents based on the respective contribution scores of the plurality of content elements and the respective contribution scores of the plurality of templates, each recommended content further comprising a template for organizing at least one content element.

4. The method of claim 3, wherein determining respective contribution scores of the plurality of templates in the conversion comprises:
for each template in the plurality of templates,
determining historical conversion parameter values corresponding to respective historical recommended contents comprising the template from the respective historical conversion parameter values corresponding to the set of historical recommended contents; and
determining a contribution score of the template based on the number of the respective historical recommended contents comprising the template and the historical conversion parameter values corresponding to the respective historical recommended contents.

5. The method of claim 1, further comprising:
generating at least one additional recommended content by randomly combining the plurality of content elements; and
providing the at least one additional recommended content together with the at least one selected recommended content to the first user group within a predetermined time period.

6. The method of claim 1, wherein obtaining historical conversion parameter values corresponding to a set of historical recommended contents related to a plurality of content elements comprises:
generating the set of historical recommended contents by randomly combining the plurality of content elements; and
after providing the set of historical recommended contents to a second user group, collecting historical conversion parameter values corresponding to the set of historical recommended contents.

7. The method of claim 1, further comprising:
after providing the at least one selected recommended content to the first user group, collecting at least one conversion parameter value corresponding to the at least one recommended content;
in response to the at least one conversion parameter value corresponding to the at least one recommended content exceeding a conversion threshold, determining at least one label of at least one content element comprised in the at least one recommended content; and
selecting, based at least on the at least one label, a content element from a content element set for generating the recommended content.

8. An electronic device, comprising:
at least one processor; and
at least one memory coupled to the at least one processor and storing instructions executed by the at least one processor, wherein the instructions, when executed by the at least one processor, cause the electronic device to perform operations comprising:
obtaining historical conversion parameter values corresponding to a set of historical recommended contents related to a plurality of content elements, each historical recommended content comprising at least one content element of the plurality of content elements;
determining respective contribution scores of the plurality of content elements in the conversion based on the historical conversion parameter values corresponding to the set of historical recommended contents;
determining, based at least on the respective contribution scores of the plurality of content elements, respective importance scores corresponding to a plurality of candidate recommended contents, each candidate recommended content comprising at least one content element of the plurality of content elements; and
selecting, based on the importance scores corresponding to the plurality of candidate recommended contents, at least one recommended content from the plurality of candidate recommended contents for providing to a first user group.

9. The electronic device of claim 8, wherein determining respective contribution scores of the plurality of content elements in the conversion comprises:
for each content element in the plurality of content elements,
determining historical conversion parameter values corresponding to respective historical recommended contents comprising the content element from the historical conversion parameter values corresponding to the set of historical recommended contents; and
determining a contribution score of the content element based on the number of the respective historical recommended contents comprising the content element and the historical conversion parameter values corresponding to the respective historical recommended contents.

10. The electronic device of claim 8, wherein each historical recommended content further comprises a template that is selected from a plurality of templates for organizing at least one content element, and wherein determining respective importance scores corresponding to the plurality of candidate recommended contents comprises:
determining respective contribution degree scores of the plurality of templates in the conversion based on the historical conversion parameter values corresponding to the set of historical recommended contents; and
determining respective importance scores corresponding to the plurality of candidate recommended contents based on the respective contribution scores of the plurality of content elements and the respective contribution scores of the plurality of templates, each recommended content further comprising a template for organizing at least one content element.

11. The electronic device of claim 10, wherein determining respective contribution scores of the plurality of templates in the conversion comprises:
for each template in the plurality of templates,
determining historical conversion parameter values corresponding to respective historical recommended contents comprising the template from the respective historical conversion parameter values corresponding to the set of historical recommended contents; and
determining a contribution score of the template based on the number of the respective historical recommended contents comprising the template and the historical conversion parameter values corresponding to the respective historical recommended contents.

12. The electronic device of claim 8, wherein the operations further comprise:
generating at least one additional recommended content by randomly combining the plurality of content elements; and
providing the at least one additional recommended content together with the at least one selected recommended content to the first user group within a predetermined time period.

13. The electronic device of claim 8, wherein obtaining historical conversion parameter values corresponding to a set of historical recommended contents related to a plurality of content elements comprises:
generating the set of historical recommended contents by randomly combining the plurality of content elements; and
after providing the set of historical recommended contents to a second user group, collecting historical conversion parameter values corresponding to the set of historical recommended contents.

14. The electronic device of claim 8, wherein the operations further comprise:
after providing the at least one selected recommended content to the first user group, collecting at least one conversion parameter value corresponding to the at least one recommended content;
in response to the at least one conversion parameter value corresponding to the at least one recommended content exceeding a conversion threshold, determining at least one label of at least one content element comprised in the at least one recommended content; and
selecting, based at least on the at least one label, a content element from a content element set for generating the recommended content.

15. A non-transitory computer-readable storage medium having a computer program stored thereon, wherein the computer program, when executed by a processor, implements operations comprising:
obtaining historical conversion parameter values corresponding to a set of historical recommended contents related to a plurality of content elements, each historical recommended content comprising at least one content element of the plurality of content elements;
determining respective contribution scores of the plurality of content elements in the conversion based on the historical conversion parameter values corresponding to the set of historical recommended contents;
determining, based at least on the respective contribution scores of the plurality of content elements, respective importance scores corresponding to a plurality of candidate recommended contents, each candidate recommended content comprising at least one content element of the plurality of content elements; and
selecting, based on the importance scores corresponding to the plurality of candidate recommended contents, at least one recommended content from the plurality of candidate recommended contents for providing to a first user group.

16. The non-transitory computer-readable storage medium of claim 15, wherein determining respective contribution scores of the plurality of content elements in the conversion comprises:
for each content element in the plurality of content elements,
determining historical conversion parameter values corresponding to respective historical recommended contents comprising the content element from the historical conversion parameter values corresponding to the set of historical recommended contents; and
determining a contribution score of the content element based on the number of the respective historical recommended contents comprising the content element and the historical conversion parameter values corresponding to the respective historical recommended contents.

17. The non-transitory computer-readable storage medium of claim 15, wherein each historical recommended content further comprises a template that is selected from a plurality of templates for organizing at least one content element, and wherein determining respective importance scores corresponding to the plurality of candidate recommended contents comprises:
determining respective contribution degree scores of the plurality of templates in the conversion based on the historical conversion parameter values corresponding to the set of historical recommended contents; and
determining respective importance scores corresponding to the plurality of candidate recommended contents based on the respective contribution scores of the plurality of content elements and the respective contribution scores of the plurality of templates, each recommended content further comprising a template for organizing at least one content element.

18. The non-transitory computer-readable storage medium of claim 10, wherein determining respective contribution scores of the plurality of templates in the conversion comprises:
for each template in the plurality of templates,
determining historical conversion parameter values corresponding to respective historical recommended contents comprising the template from the respective historical conversion parameter values corresponding to the set of historical recommended contents; and
determining a contribution score of the template based on the number of the respective historical recommended contents comprising the template and the historical conversion parameter values corresponding to the respective historical recommended contents.

19. The non-transitory computer-readable storage medium of claim 15, wherein the operations further comprise:
generating at least one additional recommended content by randomly combining the plurality of content elements; and
providing the at least one additional recommended content together with the at least one selected recommended content to the first user group within a predetermined time period.

20. The non-transitory computer-readable storage medium of claim 15, wherein obtaining historical conversion parameter values corresponding to a set of historical recommended contents related to a plurality of content elements comprises:
generating the set of historical recommended contents by randomly combining the plurality of content elements; and
after providing the set of historical recommended contents to a second user group, collecting historical conversion parameter values corresponding to the set of historical recommended contents.
